(19) United States
(12) Patent Application Publication
(10) Pub. No.: US 2020/0122196 A1
(43) Pub. Date: Apr. 23, 2020

(54) DISPLAY COVER GLASS WITH PIEZOELECTRIC TRANSDUCER ARRAY

(71) Applicant: Innovasonic, Inc., Dublin, CA (US)

(72) Inventor: Boris Kobrin, Dublin, CA (US)

(21) Appl. No.: 16/723,788

(22) Filed: Dec. 20, 2019

Related U.S. Application Data
(63) Continuation-in-part of application No. 15/645,991, filed on Jul. 10, 2017.
Application No. 15/645,991 is a continuation of application No. PCT/US2016/021836, filed on Mar. 10, 2016.
Application No. PCT/US2016/021836 is a continuation of application No. PCT/US2016/015448, filed on Jan. 28, 2016.
(60) Provisional application No. 62/784,657, filed on Dec. 24, 2018.
(60) Provisional application No. 62/888,699, filed on Aug. 19, 2019.
(60) Provisional application No. 62/117,906, filed on Mar. 16, 2015.

(51) Int. Cl. B06B 1/06; G06F 3/043; G06F 3/01

(52) U.S. Cl. CPC B06B 1/0629; G06F 3/0436; G06F 2203/04104; G06F 2203/04103; G06F 2203/04108; G06F 3/016

(57) ABSTRACT

A display with an array of piezoelectric elements fabricated on display cover glass or film and having ability to be individually controlled to provide multi-touch haptic performance, fingerprint and force sensing, health monitoring and cover glass self-cleaning function. A high resolution haptic display based on high density array of piezoelectric transducers for use as tactile single-finger Braille display, mobile electronics haptic display and sticky patch haptic display.

### 1. CLAIM OF PRIORITY

This Application is a continuation-in-pan of U.S. patent application Ser. No. 15/645,991, filed Jul. 10, 2017, the entire contents of which are incorporated herein by reference. U.S. patent application Ser. No. 15/645,991 is a continuation of International Patent Application Number PCT/US2016/021836, filed Mar. 10, 2016 and published on Oct. 25, 2018 as U.S. Patent Application Publication Number 20180309043, the entire contents of which are incorporated herein by reference. International Patent Application Number PCT/US2016/021836 is a continuation of International Patent Application Number PCT/US2016/015448, filed Jan. 28, 2016, and published on Sep. 22, 2016 as International Patent Application Publication Number WO 2016/149046, the entire disclosures of which are incorporated herein by reference. International Patent Application Number PCT/US2016/021836 claims the priority benefit of U.S. Provisional Patent application 62/117,906 filed Mar. 16, 2015, the entire contents of which are incorporated herein by reference. This application also claims the priority benefit of US Provisional Patent Application

This application claims the priority benefit of U.S. Provisional Patent Application No. 62/784,657 filed Dec. 24, 2018, the entire disclosures of which are incorporated herein by reference.

This application claims the priority benefit of U.S. Provisional Patent Application No. 62/888,699 filed Aug. 19, 2019, the entire disclosures of which are incorporated herein by reference.

### 2. FIELD OF THE DISCLOSURE

The present disclosure relates to displays used in computers, consumer electronic devices, industrial and medical products, etc. More specifically, the present disclosure relates to adding new functionalities to displays, e.g. haptics (tactile feedback), touch sensing, force sensing, fingerprints identification, medical diagnostic, and self-cleaning.

### 3. BACKGROUND

Haptics refers to the concept of enhancement of HMI by providing tactile feedback in addition to visual and audio, has been suggested few decades ago. Simple haptic feedback exists in the current smartphones, watches and game consoles, and is often implemented using bulky and electromagnetic actuators attached to devices to generating feedback forces, e.g., specific vibrations or impulses.

It is within this context that aspects of the present disclosure arise.

### 4. BRIEF DESCRIPTION OF THE DRAWINGS

FIGS. 1A-1C are schematic diagrams illustrating examples of transparent micro-structured (patterned) piezoelectric transducers array in accordance with various aspects of the present disclosure.

FIG. 2 is a side cross-section schematic diagram illustrating an example of acoustic pixel array designed in which a mesh or grid is formed by patterning both, piezoelectric layers and electrode layers.

FIG. 3 is a schematic diagram illustrating an example of an acoustic pixel array formed of discrete piezoelectric transducers mass-transferred to a device substrate.

FIG. 4 is schematic diagram showing one of embodiments of the present patent, showing high-resolution haptic single-finger Braille display.

FIG. 5 is schematic diagram showing one of embodiments of the present patent, showing high-resolution haptic foot Braille display.

FIG. 6 is a schematic diagram showing an example of a system having two or more arrays of transparent transducers fabricated on a transparent substrate such as a film or cover glass and coupled to a controller.

### 5. DETAILED DESCRIPTION

Introduction

According to aspects of the present disclosure, the capabilities of force feedback could be significantly enhanced using other types of actuation including electrostatic actuation and ultrasonic actuation. The latter has especially good potential due to a wider frequency spectrum of possible vibrations. State-of-the-art ultrasonic haptic displays use transducers attached to the edges of a display and generate only one type of vibration at any given time, since transducers launch ultrasonic waves (of specific frequency) across entire glass surface of the display screen.

This limits haptic capability to a single finger haptic feedback (or multi-finger feedback with the same feedback type). Aspects of the present disclosure propose a device capable of localized and multi-finger haptic feedback for displays.

Aspects of the present disclosure include implementations involving touch/force sensing. The most current touch screen displays use capacitance sensors, which work well in providing two-dimensional (2D) touch detection, including multi-touch. Three-dimensional (3D) touch detection, which includes force sensing, though, has been a challenge due to displacement accuracy dependence on the distance from the glass edges. Thus, alternative force sensing, such as piezoelectric sensing, has been explored. Most current force sensing technologies using the piezoelectric effect utilize transparent polymer piezoelectric materials, like poly-vinylidene fluoride or polyvinylidene difluoride (PVDF) films. This approach has two major issues preventing it from successful commercialization. The first issue is unstable force-voltage responsivity, which indicates that the same force strength induced electrical signal can be very different (up to 51%), when touch related factors, such as touch angle and touch location, are changed. The second issue is force detection mis-registration, in terms of presence and amplitude, caused by propagated stress from adjacent force touch locations. Aspects of the present disclosure envisage a system allowing true and accurate force sensing, which could also provide much higher resolution.

Other aspects of the present disclosure include implementations involving fingerprint, biometrics, or medical diagnostics. Fingerprint technologies that are currently widely used in mobile electronics are based either on an optical imaging method, mainly for OLED displays, or, a capacitive sensing method. The optical imaging method, used mainly for organic light-emitting diode (OLED) displays can be easily counterfeited. The capacitive sensing method is not very accurate and is limited to use with clean dry fingers. Recently, Qualcomm came up with in-display ultrasonic sensing technology, which is about to be deployed in Samsung Galaxy smartphones in 2019. This technology uses an ultrasonic transducer fabricated in or under the display screen. The transducer sends an ultrasonic signal to a cover glass surface and then detects reflected signal after the ultrasonic signal reflects from a finger. Unfortunately this technology is a single-finger detection technology. The ultrasonic signal travel through multiple layers before it hits a finger surface. Aspects of the present disclosure envisage a device that allows for multi-finger recognition over an entire display surface.

Additional aspects of the present disclosure include implementations involving self-cleaning. Self-cleaning technologies currently on the market are limited to only specialty coatings (e.g., hydrophobic coatings, photocatalytic coatings, etc.). Such “passive” solutions are not sufficiently reliable since the coatings need to be stripped and recoated. In addition such systems are not very efficient in that the coatings used do not prevent all contamination on the display glass surface. Aspects of the present disclosure include implenetations in which an active self-cleaning using ultrasonic energy to remove all types of contamination, including ice and fog.

Although the following detailed description contains many specific details for the purposes of illustration, anyone of ordinary skill in the art will appreciate that many variations and alterations to the following details are within the scope of the invention. Accordingly, the aspects of the disclosure described below are set forth without any loss of generality to, and without imposing limitations upon, the claimed invention.

In the following detailed description, reference is made to the accompanying drawings, which form a part hereof, and in which is shown by way of illustration specific embodiments in which the invention may be practiced. In this regard, directional terminology, such as “top,” “bottom,” “front,” “back,” “first.” “second.” etc., is used with reference to the orientation of the figure(s) being described. Because components of embodiments of the present invention can be positioned in a number of different orientations, the directional terminology is used for purposes of illustration and is in no way limiting It is to be understood that other embodiments may be utilized and structural or logical changes may be made without departing from the scope of the present invention. The following detailed description, therefore, is not to'be taken in a limiting sense, and the scope of the present invention is defined>by the appended claims.

Aspects of the present disclosure include use of matrix of piezoelectric transducers fabricated on rigid or flexible substrate. This substrate could be transparent, or opaque.

Individual transducers dimensions could be very small, from few microns to hundreds of micrometers; the distance between transducers and density of this matrix could be chosen to satisfy device technical requirements: resolution, transparency, etc.

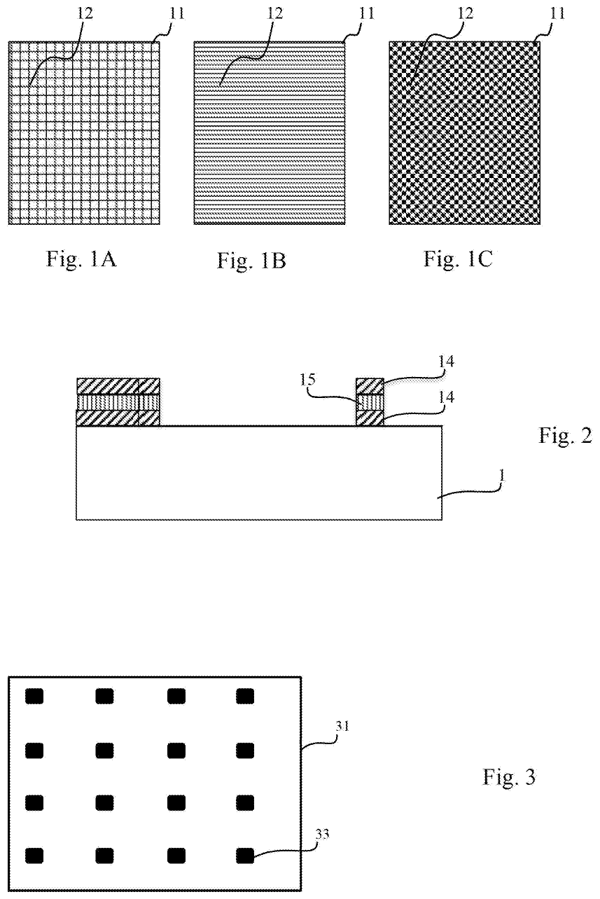

Such transducer, and method of their fabrication, have been proposed by authors earlier in PCT/US2016/015448, US 2018/0309043, U.S. 62/667.134, U.S. 62/784,657, US 2018/0358246, and may include a patterned stack of piezoelectric and/or electrode materials in the form of mesh (12) as in FIG. 1A or a grating (12′), as in FIG. 1B, or an array (12″), as in FIG. 1C on the surface of a substrate (11), for example glass or polymer film. Transparency for such transducers could be obtained by optimizing a ratio of microstructure area to an open area of the substrate. The criteria of visibility (unobstructed view) can be met by optimizing the feature size of the structure to be below recognition of a human eye at the required distances. That minimum feature size is usually less than 100 micron, sometimes less than 10 micron, though for the most demanding applications and good human vision, it could be less than 2.5 micron.

A micro-structured or nano-structured ultrasonic, transducer could be made of a piezoelectric thin film material 15 sandwiched between 2 electrodes 14, shown in FIG. 2. Moreover, both, a piezoelectric thin film 15 and electrodes 14, could be patterned on a surface of a 1 substrate to yield a very transparent and invisible-to-the-eye device. In an alternative implementation, one or both electrodes could be deposited as a continuous layer of transparent conductive material, and only piezoelectric material would be patterned. Such transparent conduct material could be, e.g., Indium-Tin Oxide (ITO) or another transparent conductive oxide (TCO), or transparent organic conductors, or graphene, or silver nanowires or nanoparticles. A piezoelectric stack could be fabricated on Silicon or other high-temperature tolerant substrate, and then transfer-printed onto glass or polymer film, or other substrate.

In some implementations, the substrate may be or may include a liquid crystal layer, e.g., as in Embodiment X, discussed below.

A patterned acoustic transducer 31 could be made of a patterned layer of piezoelectric material sandwiched between 2 transparent electrodes, as shown on FIG. 3. The patterned piezoelectric material defines an array of piezoelectric elements 33. The elements 33 may be distributed across a screen of a display. The piezoelectric elements of the array may be configured to provide haptic feedback in response to signals from electronic circuitry coupled to the array of piezoelectric elements. Moreover, both, a piezoelectric thin film and electrodes, could be patterned on the substrate surface with the individual elements being sufficiently small to yield a device that is both very transparent and invisible to the eye.

For invisibility to the eye, the individual elements that make up each transducer in the array could be less than few mm in size for far field viewing applications (e.g., a windshield, where the eyes are focused further on the road, and the windshield surface is defocused enough so that the individual elements are not distinguishable with the unaided eye). The size of the elements may be less than 10 micron (or even less than 3 micron) for close-to-the-eye applications like mobile electronics display screens.

Furthermore, transparent conductors may be used as material for the electrodes 14, instead of opaque metal. Use of transparent conductors relaxes the requirement for reduction in size of the individual elements since piezoelectric materials of suitable thickness (e.g., a few microns) are relatively transparent (transparency could be as high as 85-90% and transparent electrodes could also be transparent in that range).

In an alternative implementation, one or both electrodes could be deposited as a continuous layer of transparent conductive material, and only piezoelectric material would be patterned. Such transparent conduct material could be, e.g., Indium-Tin Oxide (ITO) or another transparent conductive oxide (TCO), or transparent organic conductors, or graphene, or silver nanowires or nanoparticles.

In another implementation, piezoelectric material could be deposited as solid layer, and only one or both electrodes could be patterned; for example, this pattern could be in the form of metal mesh.

Human fingers are the most sensitive area of human body due to high density of neural receptors. Some investigations showed that the smallest pattern that could be distinguished from the non-patterned surface had grooves with a wavelength of 760 nanometers and an amplitude of only 13 nm (Lisa Skedung, Martin Arvidsson, Jun Young Chung, Christopher M. Staffbrd, Birgitta Berglund, Mark W. Rutland. Feeling Small: Exploring the Tactile Perception Limits, Scintific Reports, 2013; 3 DOI: 10.1038/srep02617).

Patterning piezoelectric materials and/or electrodes for localized feedback—tactile image, could be done with resolution from less than 5 dots per inch (dpi), which is equivalent to approximately 5 mm pitch of acoustic transducers array to as high as 1000 dpi (equivalent to about 25 micron pitch between transducers). More practical is probably the range of resolutions between 10 dpi and 400 dpi, or even between 25 dpi and 200 dpi.

And, yet, in yet another embodiment, shown on FIG. 3, piezoelectric transducers could be fabricated on Silicon or other high-temperature tolerant substrate, and then “mass-transfer-printed” onto glass or polymer film, or other substrate material with required density of placement using one of the known mass transfer techniques, for example explained in author's patent US 201810358246.

The size of individual transducers, could be fabricated and optimized accordingly to satisfy resolution (pitch) requirements, and minimal vibration amplitude requirements.

Aspects of the present disclosure include, but are not limited to, the following embodiments.

### Embodiment I

Display cover glass has an array of piezoelectric transducers fabricated on at least one surface. Transducers are not transparent since made of inorganic non-transparent materials, like AlN, PLT, etc. At the same time, such piezoelectric materials are patterned with geometry providing sufficient transparency and avoiding obstruction of view. Less than 100 micron, and ideally, less than 10 micron, or even less than 5 micron linewidth could be necessary, and pitches between individual elements could be as small as 100 micron, or larger than 1 mm. The elements could be one dimensional (e.g., lines) or 2 dimensional (e.g., dots, squares, rectangles) or 3 dimensional (e.g., cones, cubes, semi-spheres, etc.) The pattern could be, symmetrical or asymmetrical, uniform. In or non-uniform across a surface.

The specifics of fabrication has been explained in author's prior patent applications.

Piezoelectric transducers are powered by electrical signal of specific frequency, power and mode, and as result, vibrate and emit acoustic/ultrasonic waves. Such waves/vibrations are detected by human finger as tactile feedback from glass surface generating perception of different textures (materials), different control elements on the surface (buttons, wheels, sliders), etc.

According to aspects of the present disclosure, individual transducers or groups of transducers could be controlled separately, providing capability to emit acoustic or ultrasonic waves with different frequencies, power and modes. This would allow to realize multi-touch or multi-finger haptic performance simultaneously on the same display surface.

An array of piezoelectric transducers could be fabricated directly on display cover glass or cover polymer film. Alternatively, it could be done on a stand-alone transparent substrate materials, like glass or polymer film, which then subsequently gets laminated onto display glass. Such transparent substrate could be thin or ultra-thin flexible glass, like Corning's Willow glass or similar. This open the way to integrate proposed device for flexible displays and transparent displays.

Such transparent substrate with piezoelectric array could be laminated with an array side up, and then encapsulated with additional protective transparent material, like Optically Clear. Adhesive (OSA). Alternatively, transparent substrate with, piezoelectric array could be laminated to display's cover glass with an array side down. In this case, thin glass or film substrate acts also as protective material.

### Embodiment II

Piezoelectric array of transducers responds to finger touch and pressure by generating electrical signal. Per concept described in this patent, individual transducers or groups of transducers could be controlled separately, providing capability to detect position and force exerted on each transducer separately, thus providing multi-finger touch and force sensing capabilities.

Force sensing could be obtained not only using direct, detection of pressure exerted on piezoelectric transducer. Additional information about force could be obtained by the area of contact between a finger and glass surface: the higher pressure the larger area of contact.

An additional way to detect force/pressure is to analyze the blood flow in the sub-skin blood vessels. Since ultrasonic wave can penetrate deep under finger skin and detect blood flow condition, higher pressure could block blood flow thus be detected and characterized by this device.

### Embodiment III

Piezoelectric array contains two groups, one group works as emitter of ultrasonic waves, another group works as detector of reflected from an object ultrasonic waves. Two groups are interdigitated or interlaced; alternatively the array is arranged as “pixels”. Each pixel has a pair: emitter and detector transducer. As the result the device could be called an ultrasonic “camera”.

Such camera could detect touch of one or many fingers or styluses or brush or other objects in contact with display cover glass, or even in proximity to cover glass, surface.

This camera can also analyze force of touch by detecting the area of contact between a finger and cover glass. It can also detect a force exerted by stylus if stylus is made of soft compressible material, since ultrasonic signal could detect the change in material's density.

### Embodiment IV

The ultrasonic “camera” described in Embodiment-II can be used for fingerprint identification. High density of such array could provide high resolution of detection. Ultrasonic signal is more reliable than optics when some intermediate layers like oil or moisture present between a finger and glass surface. Moreover, since ultrasonic signals penetrate under the skin and are affected by blood flow characteristics, such a device may be configured to detect such characteristics so that the device cannot be fooled by a fingerprint replica. Moreover, the information about, skin irregularities and blood flow characteristics could be used for health monitoring.

An ultrasonic “camera” fabricated over an entire display surface could be used for fingerprint identification by many fingers simultaneously, which would enhance reliability.

Such a camera with individually controlled sections could enhance reliability of fingerprint sensing, e.g., after a coverglass develops cracks, by providing redundancy to the system.

### Embodiment V

Piezoelectric transducers in array of the type described herein may be powered by electrical signals of specific frequency, power and mode, and as result, vibrate and emit acoustic/ultrasonic waves. Such waves/vibrations could be used to self-clean a display glass surface. Ultrasonic waves generated by vibrations of the acoustic transducers in an array propagate across the glass or film surface and clean it using many known ways of ultrasonic cleaning. Examples, of such ways include using surface acoustic waves (SAW) to detach contamination or ice, or cavitation cleaning in a thin layer of liquid/moisture. Fog and other liquid or organic substances may be cleared from display surface by atomization of droplets by ultrasonic energy.

### Additional Embodiments

### Embodiment VI: Braille Display for an Individual Finger

In a Braille system, a pattern of hills and divots is created on the surface. The pattern corresponds to a Braille code representing characters of a specific alphabet. In a tactile display, the pattern of hills and divots could be static (if fabricated on a surface as permanent surface relief), or reconfigurable, e.g., if the hills are actuated using pin-array or other mechanical types of actuation. A person moves its finger across the area and receives sequence of codes, which then translates into text or other useful information.

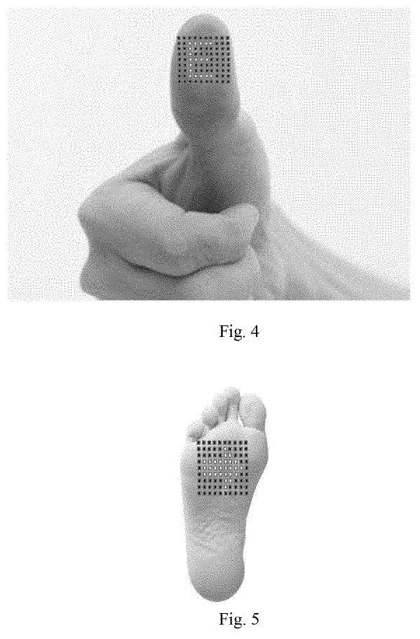

Aspects of the present disclosure include a Braille display system that does not require finger movement in order to receive necessary information. A Braille display in accordance with aspects of the present disclosure may include a high resolution matrix of acoustic pixels in a relatively small area, e.g., about 1 square inch. Once a user's finger is positioned in contact with such a tactile display, a series of symbols or shapes could be “displayed” in sequence to provide necessary information, e.g., as shown in FIG. 4. The symbols or shapes could be letters of specific language, or different signs. The display may operate in a static mode in which one symbol displayed within specific time interval, then changed to a dynamic mode, where each symbol or sign is “drawn” on a finger surface sequentially to present text information letter by letter, or word by word. Furthermore, the signs or shapes or other images may change in a sequence and with a speed corresponding to animation or video. The speed of changing these symbols or drawing them, and intensity/tactile force could be controlled individually by user to fit person's sensitivity.

### Embodiment VII

The acoustic pixel array tactile display explained in Embodiment-I is useful not only for visually-impaired people but, could be used in regular mobile electronics devices, e.g., smartphones, tablets, smartwatches, appliances and vehicles as enhanced high-resolution haptic devices to enhance customer experience through haptic feedback on a display touch screen or cover glass or on the edges or back of the device. Aspects of the present disclosure include an implementation involving a smartphone with this device fabricated on the back or side of the phone case, so that a user can get additional information through haptic feedback while holding the phone. Such information could be much more informative and sophisticated than today (buzz) and could include some text or warnings. This information could be delivered through multiple fingers holding the phone or palm touching the phone's back surface. By way of example, and not by way of limitation, a smartwatch may have an acoustic pixel array on a backside thereof so that the array is in continuous contact with a user's skin when worn.

Embodiment VIII: The acoustic pixel array tactile display explained in Embodiment-I could be fabricated on an adhesive biocompatible patch, which could be attached to person's body part (e.g., arm, leg, etc) to forward text or warning information or for therapeutic purposes. An additional circuit for wireless transmission of information and power from near-by smartphone or computer may be coupled to the acoustic pixel array and/or incorporated into the display device. In such an implementations, the acoustic pixel array tactile display could obtain information wirelessly from a nearby computer or mobile electronic device, or from RF communication network directly. Furthermore, a battery could be attached to power the device.

### Embodiment IX

The acoustic pixel array tactile display explained in Embodiment-I could be installed on the sole of the foot, as shown on FIG. 5 or on a device worn on the foot. This way smartphone could transmit information about direction right, to the foot.

### Embodiment-X

The acoustic pixel array could work as visual display if combined with material changing its optical properties when actuated using acoustic/ultrasonic vibrations. For example, the effect of switching holographic polymer-dispersed liquid crystal (H-PDLC) gratings driven by surface acoustic waves (SAWs) is known. The diffraction of the H-PDLC grating decreased, whereas the transmission increased. This acoustically switchable behavior is due to the acoustic streaming-induced realignment of liquid crystals as well as absorption-resulted thermal diffusion. This phenomena could be used to create high resolution visual displays based on acoustic pixel array suggested in this patent in combination with H-PDLC materials. Both, reflective or transparent displays could be fabricated using this technique.

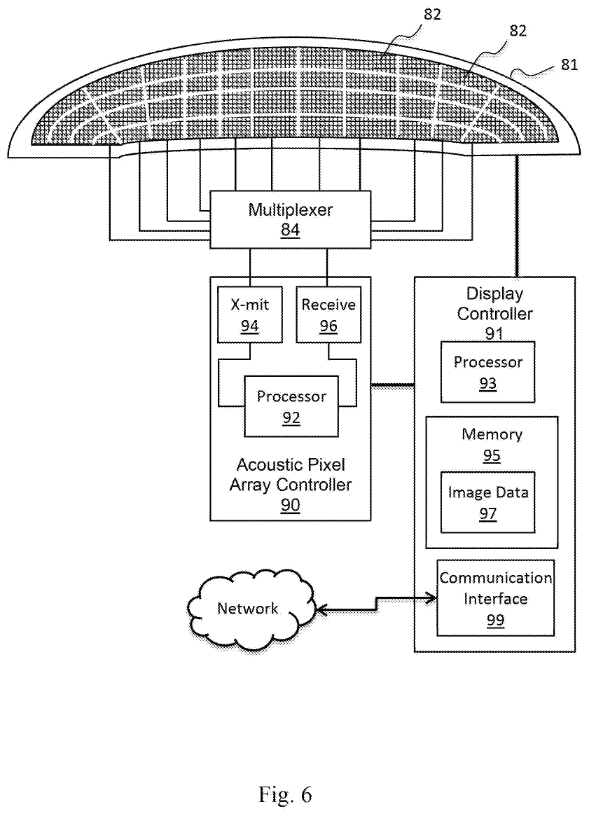

There are a number of ways to implement the above Embodiments. By way of example, and not by way of limitation, FIG. 6 illustrates a system having two or more arrays of transparent transducers 82 fabricated on a transparent substrate 81 and coupled to an acoustic pixel array controller 90. The controller may include a processor 92 coupled to a transmit circuit 94 and a receive circuit 96. In the illustrated example, the arrays of transparent transducers 82 are operatively coupled to the controller 90 via a multiplexer 84. The multiplexer allows the transmit circuit 94 or the receive circuit 96 to be selectively coupled to individual transducers or groups of transducers on the substrate 81. The processor 92 may be a programmable microprocessor, a microcontroller, an application specific integrated circuit (ASIC), field programmable gate array (FPGA), or other suitable device. It is noted that in some implementations, the multiplexer 84, processor 92, transmit circuit 94, and receive circuit 96 may be implemented in a common integrated circuit, such as a system on chip (SOC).

The transmit circuit 94 provides drive signals that drive the transducers 82 in response to drive instructions from the processor 92. Providing the drive instructions may involve interpretation of digital drive instructions and generation of corresponding analog output signals having sufficient amplitude to generate a desired ultrasound signal with a particular transducer. The drive signals may include switching signals that direct the multiplexer 84 to selectively couple the analog output signals to the particular transducer. By way of example and not by way of limitation, the processor 92 may send drive instructions to the transmit circuit 94 that direct the transmit circuit to couple drive signals to selected arrays in a sequence that sends transverse waves of ultrasound across the substrate from one end to the other.

The receive circuit receives 96 input signals from the transducers 82 and converts the received signals into a suitable form for signal processing by the processor. Conversion of the received signals may involve amplification of the received signals and conversion of the resulting amplified received signals from analog to digital form. The processor may be programmed or otherwise configured to perform digital signal processing on the resulting digital signals. Such digital signal processing may include time of flight analysis to determine a distance d to an object. Such time of flight analysis may involve determining an elapsed time At between the transmitting of acoustic pulses with one or more of the transducers 82 and detecting an echo of such pulses from the object with the same or different transducers 82. The processor 92 can calculate the distance d from the equation d=cΔt, where c is a known or estimated speed of sound.

In some implementations the transparent substrate 81 is either part of a display or is attached to a screen of such a display. The screen may be, e.g., a flat panel or cathode ray tube (CRT) screen. In such implementations, the display may be operable to present images and/or text or other graphical symbols in response to signals from a display controller 91, which may be coupled to the acoustic pixel array controller 90. The controller may include a processor 93 and memory 95. Image data 97 may be stored in the memory 95. The processor 93 may be configured, e.g., through appropriate integrated circuitry or programming, to generate signals that control intensity and/or color and pixel locations on the screen.

In some implementations, e.g., the smartwatch described above, it may be desirable for the display controller 91 to include a communication interface 99, e.g., a radiofrequency (RF), Bluetooth, or other wireless interface to allow the device to communicate with other devices over a network. Information obtained by the array of acoustic transducers 82 could be forwarded wirelessly to a nearby computer or mobile electronic device and sent through RF communication network directly, or stored on a mobile storage media. In addition, information may be transmitted to the array 82 from external devices via the communication interface 99 and acoustic pixel array controller 90.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation, is explicitly recited in a given claim using the phrase “means for.”

1. A display device, comprising:
a transparent array of piezoelectric elements distributed across a screen or coverglass of the display, wherein piezoelectric elements of the array are configured to provide haptic feedback in response to signals from electronic circuitry coupled to the array of piezoelectric elements.

2. The device of claim 1 wherein one or more piezoelectric elements or one or more groups of piezoelectric elements of the array of piezoelectric elements are separately controlled to provide localized haptic feedback.

3. The device of claim 1 wherein one or more piezoelectric elements or one or more groups of piezoelectric elements of the array of piezoelectric elements are configured to be separately controlled to provide multi-finger and finger-dependent haptic feedback.

4. The device of claim 1 wherein the array of piezoelectric elements is fabricated on a cover glass or cover film on the screen of the display.

5. The device of claim 1 wherein the array of piezoelectric elements is fabricated on transparent glass or polymer film substrate attached to a cover glass or film on the screen of the display.

6. The device of claim 1, further comprising the electronic circuitry.

7. A display device, comprising:
a transparent array of piezoelectric elements distributed across a screen or coverglass of the display, wherein piezoelectric elements of the array are configured to provide touch and force sensing signals to electronic circuitry coupled to the array of piezoelectric elements in response to changes in pressure.

8. The device of claim 7 wherein one or more piezoelectric elements or one or more groups of piezoelectric elements of the array of piezoelectric elements are separately controlled, to provide localized and multi-finger touch and force sensing.

9. The device of claim 7, wherein the array of piezoelectric elements is fabricated on a cover glass or cover film of the display.

10. The device of claim 7, wherein the array of piezoelectric elements is configured to also provide energy harvesting or wireless charging to the electronic circuitry coupled to the array of piezoelectric elements or to different electronic circuitry coupled to the array of piezoelectric elements.

11. The device of claim 10, wherein one or more piezoelectric elements or one or more groups of piezoelectric elements of the array of piezoelectric elements are configured to generate an electrical signal in response to application of pressure.

12. The device of claim 7, wherein one or more piezoelectric elements or one or more groups of piezoelectric elements of the array of piezoelectric elements are configured to an emit ultrasonic signal in response to one or more electrical signals from the electronic circuitry, wherein another one or more piezoelectric elements or one or more groups of piezoelectric elements of the array of piezoelectric elements are configured, to detect an acoustic signal corresponding to a reflection of the ultrasonic signal from an object, wherein the electronic circuitry is configured to analyze the acoustic signal and provide information about a position of the object or an area of contact between the object and a surface to which the array of piezoelectric elements is attached.

13. The device of claim 7, further comprising the electronic circuitry.

14. A display device, comprising:
a transparent array of piezoelectric elements distributed across a screen or coverglass of the display, wherein such array provides fingerprint and other biometric identification and health monitoring.

15. The device of claim 14 wherein one group of such elements of an array emit ultrasonic signal, which after bouncing off a finger surface is detected by another group of such elements of an array, thus providing information about groves pattern on each fingerprint.

16. The device of claim 14 wherein such array is fabricated on separate transparent glass or polymer film substrate laminated on display's cover glass or film.

17. The device of claim 14 wherein ultrasonic signal penetrates deep under finger's skin and detects information about skin and blood flow to provide some health monitoring functions.

18. The device of claim 14 wherein such elements or groups of such elements of array are separately controlled, providing multi-finger fingerprint and health monitoring information.

19. The device of claim 14, further comprising the electronic circuitry.

20. A display containing a transparent array of piezoelectric elements. distributed on cover glass or film of a display, wherein the array of piezoelectric elements is configured to provide a self-cleaning function to the cover glass or film.

21. The device of claim 20 wherein the array of piezoelectric elements is configured to provide the self-cleaning function by generating surface acoustic waves.

22. The device of claim 20 wherein the array of piezoelectric elements is configured to provide the self-cleaning function by ultrasonic cavitation.

23. The device of claim 20 wherein the array of piezoelectric elements is configured to provide the self-cleaning function by ultrasonic evaporation.

24. The device of claim 20 wherein the array of piezoelectric elements includes one or more piezoelectric elements or one or more groups of piezoelectric elements that are separately controlled to provide localized cleaning.

25. The device of claim 20 wherein the array of piezoelectric elements is fabricated on a separate transparent glass or polymer film substrate laminated on the cover glass or film.

26. A haptic display device, comprising:
an array of acoustic transducers distributed across essentially an entire surface of a display surface, wherein the resolution of such array is higher than 5 dots per inch (dpi); and a controller configured to individually powers each transducer or groups of transducers of the array of acoustic transducers.

27. The device of claim 26 wherein a density of transducers in the array of acoustic transducers is higher than 20 dpi.

28. The device of claim 26 wherein a density of transducers in the array of acoustic transducers is higher than 50 dpi.

29. The device of claim 26 wherein a density of transducers in the array of acoustic transducers is higher than 100 dpi.

30. The device of claim 26, wherein the array of acoustic transducers is configured to obtain information in response to a finger being in contact with the display surface in a static regime that does not require any finger movement for information transfer, and wherein the array of acoustic transducers is configured to deliver spatially resolved vibrations to the finger representing a tactile image in the form of signs or shapes.

31. The device of claim 30 wherein the signs or shapes include letters of a language.

32. The device of claim 30 wherein tactile image includes a picture.

33. The device of claim 30 wherein the signs or shapes are static.

34. The device of claim 30 wherein the signs and shapes change in a sequence, providing text information letter by letter, or word by word.

35. The device of claim 30 wherein the signs or shapes are displayed as a propagating signal, like writing a letter or moving an object on a finger surface.

36. The device of claim 30 wherein the signs or shapes correspond to animation or video.

37. The device of claim 30 wherein the signs or shapes correspond to Braille characters.

38. The device of claim 30 wherein such the display device is incorporated into a mobile electronics device to enhance customer experience through haptic feedback.

39. The device of claim 30 wherein the device is part of a vehicle, appliance or industrial instrument.

40. The device of claim 26 wherein the haptic display device is on a backside of a smartwatch.

41. The device of claim 26 wherein the device fabricated as an adhesive patch.

42. The device of claim 41, further comprising a communication interface operably coupled to the array of acoustic transducers.

43. A haptic display, comprising:
an array of acoustic transducers distributed across essentially an entire display surface;
a liquid crystal layer disposed over such an array, wherein liquid crystal layer is switchable by surface acoustic waves emitted by such acoustic transducers, and a controller configured to power one or more transducers of the array of acoustic transducers,
wherein a density of transducers in the array of acoustic transducers is higher than 5 dots per inch (dpi).

44. The device of claim 43 wherein the density of such transducers are higher than 50 dpi.

45. The device of claim 43 wherein the density of such transducers are higher than 100 dpi.

46. The device of claim 43 wherein liquid crystal layer is polymer-dispersed liquid crystal.
